(19) United States
(12) Patent Application Publication
(10) Pub. No.: US 2017/0043708 A1
(43) Pub. Date: Feb. 16, 2017

(54) VEHICLE TRACKING SYSTEM

(71) Applicants: Curtis Watson, Dover, DE (US); Angela Watson, Dover, DE (US)

(72) Inventors: Curtis Watson, Dover, DE (US); Angela Watson, Dover, DE (US)

(21) Appl. No.: 14/826,651

(22) Filed: Aug. 14, 2015

(51) Int. Cl. B60Q 1/26; H05B 37/02; B60Q 1/50

(52) U.S. Cl. CPC B60Q 1/2615; B60Q 1/50; H05B 37/0272

(57) ABSTRACT

A vehicle tracking system includes a vehicle that has a back side. A tracking unit is coupled to the vehicle such that the tracking unit may be visible to an observer thereby facilitating the observer to follow the vehicle. The tracking unit comprises a base unit that is removably coupled to the back side. The tracking unit further comprises a remote unit that may be carried by a driver of the vehicle. The remote unit is operationally coupled to the base unit such that the remote unit turns the base unit on and off.

### BACKGROUND OF THE DISCLOSURE

### Field of the Disclosure

The disclosure relates to tracking devices and more particularly pertains to a new tracking device for facilitating a vehicle to be followed by an observer.

### SUMMARY OF THE DISCLOSURE

An embodiment of the disclosure meets the needs presented above by generally comprising a vehicle that has a back side. A tracking unit is coupled to the vehicle such that the tracking unit may be visible to an observer thereby facilitating the observer to follow the vehicle. The tracking unit comprises a base unit that is removably coupled to the back side. The tracking unit further comprises a remote unit that may be carried by a driver of the vehicle. The remote unit is operationally coupled to the base unit such that the remote unit turns the base unit on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a vehicle tracking system according to an embodiment of the disclosure.

FIG. 2 is a back view of an embodiment of the disclosure.

FIG. 3 is a top perspective view of an embodiment of the disclosure.

FIG. 4 is a front view of an embodiment of the disclosure.

FIG. 5 is a back perspective view of an embodiment of the disclosure.

FIG. 6 is a schematic view of an embodiment of the disclosure.

FIG. 7 is a perspective in-use view of an embodiment of the disclosure.

### DESCRIPTION OF THE PREFERRED EMBODIMENT

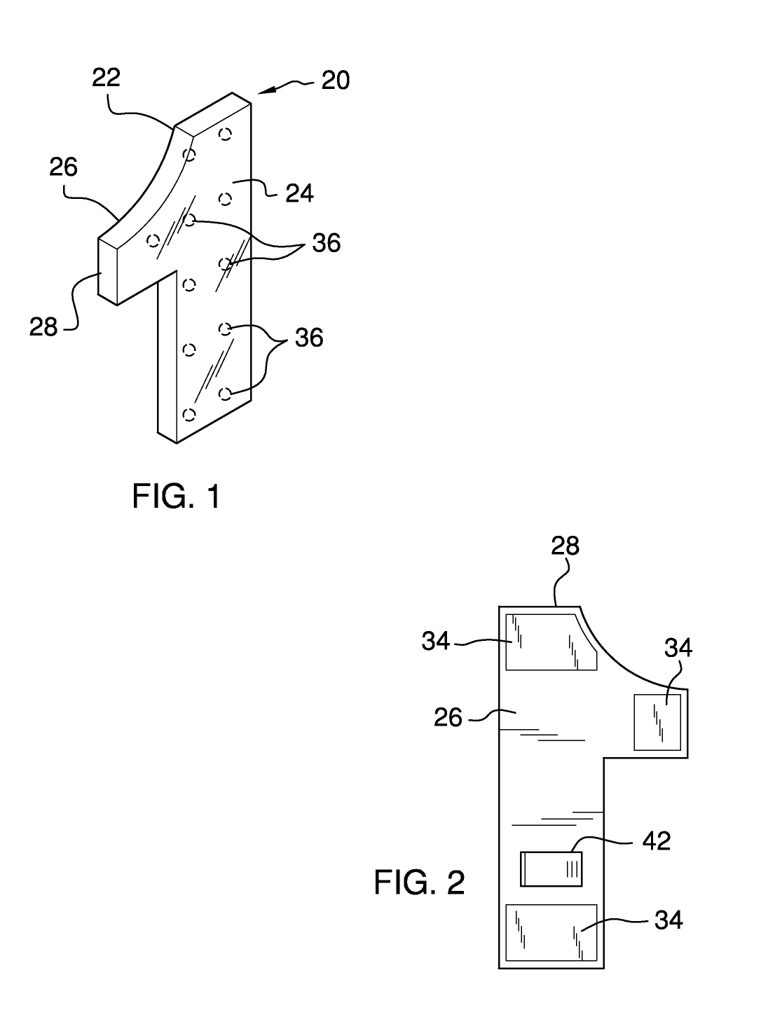

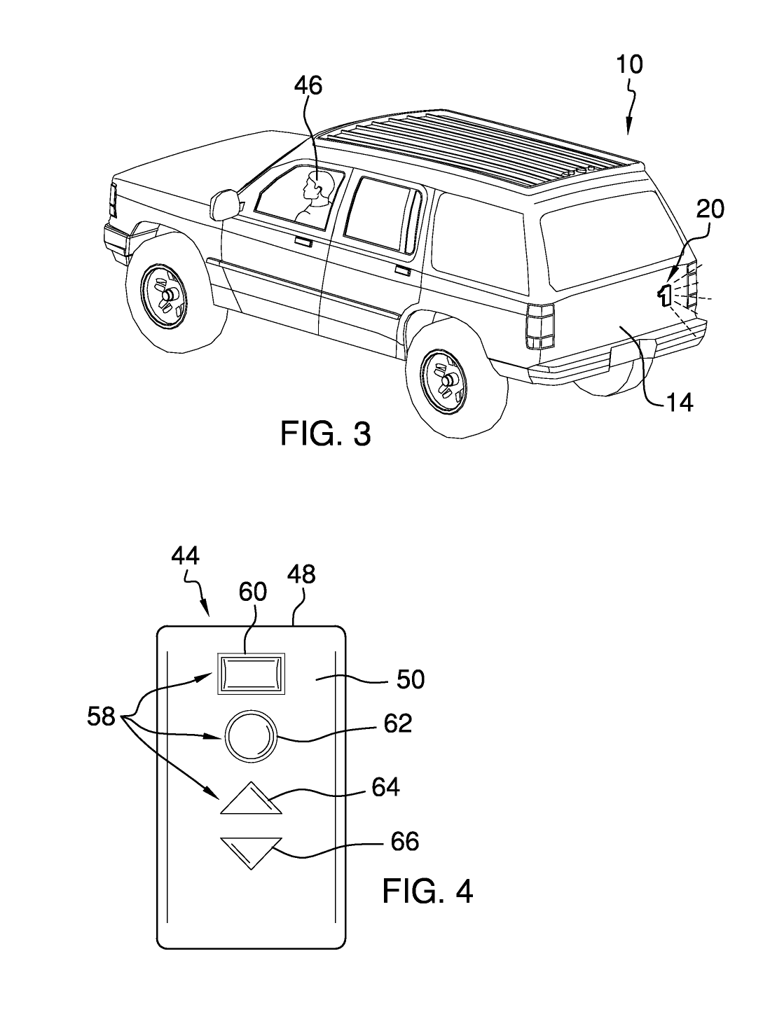

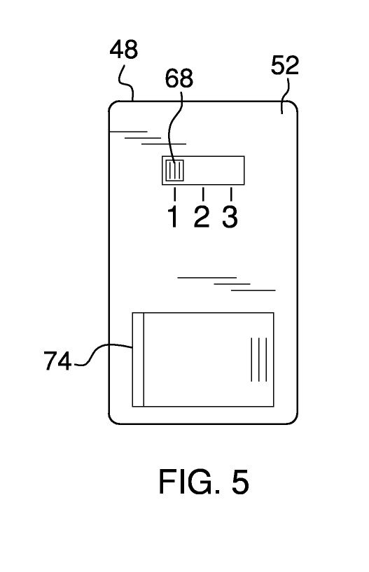

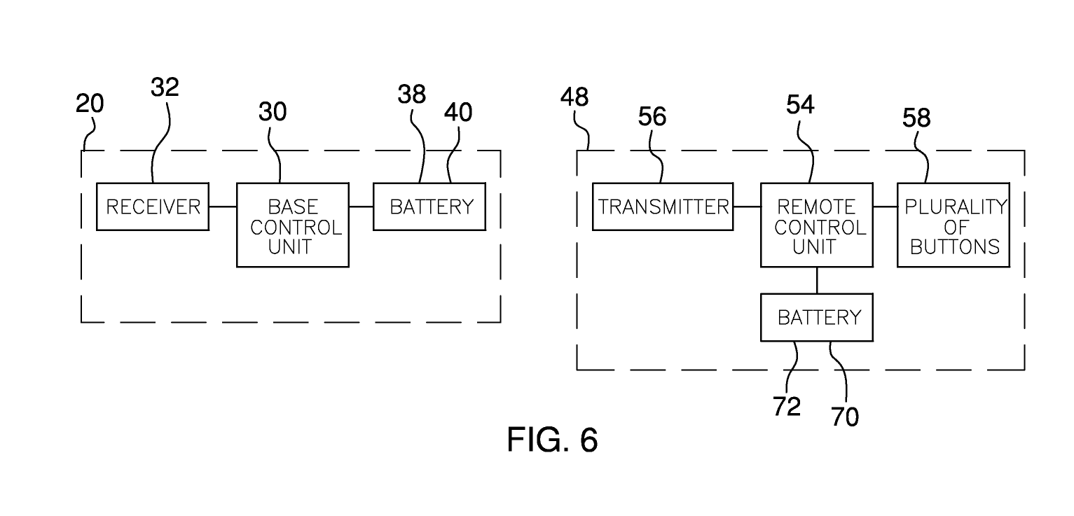

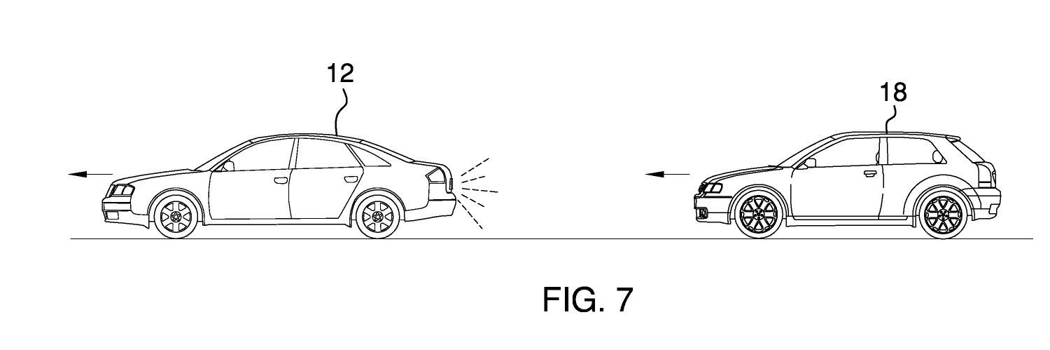

With reference now to the drawings, and in particular to FIGS. 1 through 7 thereof, a new tracking device embodying the principles and concepts of an embodiment of the disclosure and generally designated by the reference numeral 10 will be described.

As best illustrated in FIGS. 1 through 7, the vehicle tracking system 10 generally comprises a vehicle 12 that has a back side 14 and the vehicle 12 may be a passenger vehicle or the like. A tracking unit 16 is coupled to the vehicle 12 such that the tracking unit 16 is visible to an observer 18 thereby facilitating the observer 18 to follow the vehicle 12. The tracking unit 16 comprises a base unit 20 that is removably coupled to the back side 14.

The base unit 20 comprises a base housing 22 that has a front side 24, a back side 26 and a peripheral side 28 extending between the front side 24 and the back side 26. The base housing 22 is comprised of a translucent material and a base control circuit 30 is positioned within the base housing 22. The base control circuit 30 may be an electronic processor or the like. A receiver 32 is positioned within the base housing 22 and the receiver 32 is electrically coupled to the base control circuit 30. The receiver 32 may comprise a radio frequency receiver capable of utilizing multiple channels of radio frequency.

A plurality of fasteners 34 is provided and each of the fasteners 34 is coupled to the back side 26 of the base housing 22. Each of the fasteners 34 magnetically engages the back side 26 of the vehicle 12 such that the base housing 22 is removably retained on the back side 26 of the vehicle 12. The peripheral side 28 of the base housing 22 may have a plurality of intersection sides such that the base housing 22 is shaped like the number 1.

A plurality of light emitters 36 is provided and each of the light emitters 36 is positioned within the base housing 22. Each of the light emitters 36 is electrically coupled to the base control circuit 30 and each of the light emitters 36 emits light. Thus, the light emitters 36 are visible to the observer 18 thereby facilitating the observer 18 to distinguish the vehicle 12 from surrounding vehicles.

A base power supply 38 is positioned within the base housing 22 and the base power supply 38 is electrically coupled to the base control circuit 30. The base power supply 38 comprises at least one battery 40. A battery cover 42 is removably coupled to the back side 26 of the base housing 22. The power supply 38 is positioned beneath the battery cover 42.

The tracking unit 16 further comprises a remote unit 44 that may be carried by a driver 46 of the vehicle 12. The remote unit 44 is operationally coupled to the base unit 20 such that the remote unit 44 turns the base unit 20 on and off. The remote unit 44 comprises a remote housing 48 that has a front side 50 and a back side 52.

A remote control circuit 54 is positioned within the remote housing 48 and the remote control circuit 54 may comprise an electronic processor or the like. A transmitter 56 is positioned within the remote housing 48 and the transmitter 56 is electrically coupled to the remote control circuit 54. The transmitter 56 is in electrical communication with the receiver 32 and the transmitter 56 may comprise a radio frequency transmitter capable of utilizing multiple channels of radio frequency.

A plurality of buttons 58 is provided and each of the buttons 58 is positioned on the front side 50 of the remote housing 48. Each of the buttons 58 is electrically coupled to the remote control circuit 54 such that each of the buttons 58 controls operational parameters of the base unit 20. The plurality of buttons 58 may include an on/off one 60 of the buttons 58, a blink one 62 of the buttons 58, an increase one 64 of the buttons 58 and a decrease one 66 of the buttons 58.

The on/off button 60 turns the light emitters 36 on and off. The blink button 62 actuates the light emitters 36 to blink repeatedly. The increase button 64 increases a rate at which the light emitters 36 blink and the decrease button 66 decreases a rate at which the light emitters blink 36. A channel switch 68 is positioned on the back side 52 of the remote housing 44. The channel switch 68 is electrically coupled to the remote control circuit 54 and the channel switch 68 selects one of the radio frequency channels utilized by the transmitter 56.

A remote power supply 70 is positioned within the remote housing 48 and the remote power supply 70 is electrically coupled to the remote control circuit 54. The remote power 70 supply comprises at least one battery 72. A battery cover 74 is removably coupled to the back side 52 of the remote housing 44 and the remote power supply 70 is positioned beneath the battery cover 74 on the remote housing 48.

In use, the base housing 22 is magnetically coupled to the back side 14 of the vehicle 12. The on/off button 60 is manipulated to actuate the light emitters 36. The blink button 62 may be manipulated to actuate the light emitters 36 to blink and the rate of blinking may be selected. The light emitters 36 facilitate the observer 18 to follow the vehicle 12 when the vehicle 12 is being operated in heavy traffic conditions or the like.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle tracking system comprising:
a vehicle having a back side; and
a tracking unit being coupled to said vehicle wherein said tracking unit is configured to be visible to an observer thereby facilitating the observer to follow said vehicle, said tracking unit comprising a base unit being removably coupled to said back side, said tracking unit comprising a remote unit configured to be carried by a driver of said vehicle, said remote unit being operationally coupled to said base unit such that said remote unit turns said base unit on and off.

2. The system according to claim 1, wherein said base unit comprises a base housing having a front side, a back side and a peripheral side extending between said front side and said back side, said housing being comprised of a translucent material.

3. The system according to claim 2 further comprising:
a base control circuit being positioned within said base housing; and
a receiver being positioned within said base housing, said receiver being electrically coupled to said base control circuit.

4. The system according to claim 3, wherein a plurality of light emitters, each of said light emitters being positioned within said base housing, each of said light emitters being electrically coupled to said base control circuit, each of said light emitters emitting light wherein said light emitters are configured to be visible to the observer.

5. The system according to claim 3, wherein a base power supply being positioned within said base housing, said base power supply being electrically coupled to said base control circuit, said base power supply comprising at least one battery.

6. The system according to claim 1, wherein said remote unit comprises:
a remote housing having a front side and a back side;
a remote control circuit being positioned within said remote housing; and
a transmitter being positioned within said remote housing, said transmitter being electrically coupled to said remote control circuit, said transmitter being in electrical communication with said receiver.

7. The system according to claim 6, further comprising a plurality of buttons, each of said buttons being positioned on said front side of said remote housing, each of said buttons being electrically coupled to said remote control circuit wherein each of said buttons controls operational parameters of said base unit.

8. The system according to claim 6, further comprising a remote power supply being positioned within said remote housing, said remote power supply being electrically coupled to said remote control circuit, said remote power supply comprising at least one battery.

9. A vehicle tracking system comprising:
a vehicle having a back side; and
a tracking unit being coupled to said vehicle wherein said tracking unit is configured to be visible to an observer thereby facilitating the observer to follow said vehicle, said tracking unit comprising a base unit being removably coupled to said back side, said base unit comprising:
a base housing having a front side, a back side and a peripheral side extending between said front side and said back side, said housing being comprised of a translucent material,
a base control circuit being positioned within said base housing,
a receiver being positioned within said base housing, said receiver being electrically coupled to said base control circuit,
a plurality of light emitters, each of said light emitters being positioned within said base housing, each of said light emitters being electrically coupled to said base control circuit, each of said light emitters emitting light wherein said light emitters are configured to be visible to the observer, and
a base power supply being positioned within said base housing, said base power supply being electrically coupled to said base control circuit, said base power supply comprising at least one battery;
said tracking unit comprising a remote unit configured to be carried by a driver of said vehicle, said remote unit being operationally coupled to said base unit such that said remote unit turns said base unit on and off, said remote unit comprising:
a remote housing having a front side and a back side,
a remote control circuit being positioned within said remote housing,
a transmitter being positioned within said remote housing, said transmitter being electrically coupled to said remote control circuit, said transmitter being in electrical communication with said receiver,
a plurality of buttons, each of said buttons being positioned on said front side of said remote housing, each of said buttons being electrically coupled to said remote control circuit wherein each of said buttons controls operational parameters of said base unit, and
a remote power supply being positioned within said remote housing, said remote power supply being electrically coupled to said remote control circuit, said remote power supply comprising at least one battery.
